(19) United States
(12) Patent Application Publication
(10) Pub. No.: US 2026/0194745 A1
(43) Pub. Date: Jul. 9, 2026

(54) MEMS SCANNING MIRROR AND LIDAR SYSTEM

(71) Applicant: inSync Resonance Inc, Fremont, CA (US)

(72) Inventor: Qin ZHOU, Fremont, CA (US)

(21) Appl. No.: 19/014,258

(22) Filed: Jan. 9, 2025

(51) Int. Cl. G02B 26/08; G01S 7/481; G02B 26/10

(52) U.S. Cl. CPC G02B 26/0841; G01S 7/4817; G02B 26/105

(57) ABSTRACT

Provided are a MEMS scanning mirror and a LiDAR system. The MEMS scanning mirror includes: at least two micro mirror groups formed at a MEMS substrate, each of the at least two micro mirror groups including a plurality of micro mirrors adjacent to each other; at least two actuator groups arranged in a one-to-one correspondence with the at least two micro mirror groups, actuators in each of the at least two actuator groups being configured to drive micro mirrors in a corresponding one of the at least two micro mirror groups to tilt; and a driving signal generator configured to output a driving signal to each of the at least two actuator groups, to enable each of the at least two actuator groups to drive, based on the driving signal, the micro mirrors in the corresponding one of the at least two micro mirror groups to tilt synchronously.

### FIELD

The present disclosure relates to the field of light detection and ranging technologies, and more particularly, to a micro-electro-mechanical system (MEMS) scanning mirror and a light detection and ranging (LiDAR) system.

### BACKGROUND

MEMS is a technology that fabricates mechanical components on a semiconductor device. One application scenario of the MEMS is in fabrication of a MEMS scanning mirror, which typically includes multiple micro mirrors. The multiple micro mirrors can be arranged in an array. An actuator array can be manufactured at the MEMS. Each actuator in the actuator array is configured to drive one micro mirror. By driving the multiple micro mirrors to tilt synchronously, an effect that the multiple micro mirrors can be equivalent to a scanning mirror of a larger area can be achieved. However, due to a large quantity of micro mirrors in the MEMS scanning mirror, how to maintain synchronous tilting is an important problem to be solved.

Generally, a same driving signal is simultaneously applied to actuators in the actuator array to achieve an effect of driving the multiple micro mirrors to tilt synchronously. However, since the above mentioned actuators are generally prepared at the MEMS through etching and other processes, there may be variations in a manufacturing process, which leads to differences in performance parameters of the finished actuators. Such differences lead to differences in operation parameters of the actuators even when the same driving signal is applied to the actuators, which in turn affects tilting synchronization between the multiple micro mirrors in the MEMS scanning mirror.

### SUMMARY

The present disclosure aims to solve at least one of the technical problems in the related art. To this end, the present disclosure provides a MEMS scanning mirror and a LiDAR system, capable of improving tilting synchronization between multiple micro mirrors in the MEMS scanning mirror.

In a first aspect, the present disclosure provides a MEMS scanning mirror. The MEMS scanning mirror includes: at least two micro mirror groups formed at a MEMS substrate, each of the at least two micro mirror groups including a plurality of micro mirrors adjacent to each other; at least two actuator groups arranged in a one-to-one correspondence with the at least two micro mirror groups, actuators in each of the at least two actuator groups being configured to drive micro mirrors in a corresponding one of the at least two micro mirror groups to tilt; and a driving signal generator configured to output a driving signal to each of the at least two actuator groups, enabling each of the at least two actuator groups to drive, based on the driving signal, the micro mirrors in the corresponding one of the at least two micro mirror groups to tilt synchronously.

In some embodiments, the plurality of micro mirrors are arranged in an array at the MEMS substrate, each of the at least two micro mirror groups including at least two rows of micro mirrors adjacent to each other, and/or each of the at least two micro mirror groups including at least two columns of micro mirrors adjacent to each other.

In some embodiments, the driving signal generator includes: at least two driving signal generation units arranged in a one-to-one correspondence with the at least two actuator groups, each of the at least two driving signal generation units being configured to output the driving signal to a corresponding one of the at least two actuator groups.

In some embodiments, the MEMS scanning mirror further includes: a driving signal modulator configured to modulate, based on signal modulation parameters of the at least two actuator groups, the driving signals outputted by the driving signal generator, and apply the modulated driving signals to the at least two actuator groups, the signal modulation parameter being used to enable the plurality of micro mirrors in different micro mirror groups to tilt synchronously.

In some embodiments, the signal modulation parameter is obtained by performing a synchronous performance detection on the plurality of micro mirrors in different micro mirror groups.

In some embodiments, the signal modulation parameter includes at least one of a signal amplitude ratio of the driving signals between different actuator groups or a phase difference of the driving signals between different actuator groups.

In some embodiments, the driving signal modulator includes: a parameter storage module configured to store the signal modulation parameter of the at least two actuator groups; and a signal modulation module configured to read the signal modulation parameter from the parameter storage module and modulate the driving signals of the at least two actuator groups based on the signal modulation parameter.

In some embodiments, the driving signal modulator includes: a signal modulation circuit arranged in parallel and/or in series with a corresponding one of the at least two actuator groups, the signal modulation circuit being configured to modulate the driving signal outputted by the driving signal generator, and the signal modulation circuit being prepared at the MEMS substrate based on the signal modulation parameter of the at least two actuator groups or arranged externally.

In some embodiments, the signal modulation circuit includes a resistor-capacitor network.

In some embodiments, the at least two micro mirror groups include a first micro mirror group and a second micro mirror group, the first micro mirror group and the second micro mirror group being used for a beam emitting side and a beam receiving side, respectively.

In a second aspect, embodiments of the present disclosure further provide a LiDAR system. The LiDAR system includes a light source, a photodetector, a processor, and a MEMS scanning mirror. A laser beam emitted by the light source is reflected to a target region by the MEMS scanning mirror. The photodetector is configured to receive at least part of reflected light from the target region and convert the at least part of the reflected light into an electrical signal. The processor is configured to obtain a laser point cloud from the target region based on the electrical signal. The MEMS scanning mirror includes: at least two micro mirror groups formed at a MEMS substrate, each of the at least two micro mirror groups including a plurality of micro mirrors adjacent to each other; at least two actuator groups arranged in a one-to-one correspondence with the at least two micro mirror groups, actuators in each of the at least two actuator groups being configured to drive micro mirrors in a corresponding one of the at least two micro mirror groups to tilt; and a driving signal generator configured to output a driving signal to each of the at least two actuator groups, enabling each of the at least two actuator groups to drive, based on the driving signal, the micro mirrors in the corresponding one of the at least two micro mirror groups to tilt synchronously.

The above MEMS scanning mirror also has all the technical features described in the first aspect. Reference can be made to the above description for details

With the MEMS scanning mirror and the LiDAR system according to the embodiments of the present disclosure, micro mirrors in a micro mirror array at the MEMS are grouped based on positions to obtain the at least two micro mirror groups. Each micro mirror group may include multiple micro mirrors adjacent to each other in position. In addition, multiple actuators in an actuator array are also grouped into the at least two actuator groups arranged in the one-to-one correspondence with the at least two micro mirror groups. Actuators in each actuator group are configured to drive the micro mirrors in the corresponding one of the at least two micro mirror groups to tilt. A specific correspondence between actuators and micro mirrors may be a one-to-one correspondence, a one-to-many correspondence, or a many-to-one correspondence, which is not limited in the embodiments of the present disclosure, but the actuators in each actuator group are also adjacent to each other in position. Due to an influence of semiconductor manufacturing processes, the performance parameters of the multiple actuators have regional distribution characteristics. In the embodiments of the present disclosure, the micro mirror array and the actuator array are each grouped. For different micro mirror groups and actuator groups, since the micro mirrors in a same micro mirror group are adjacent to each other in position and the actuators in a same actuator group are also adjacent to each other in position, a consistency of the performance parameters of the actuators in the same actuator group is desirable. In this way, when the actuator group is driven by a same driving signal, synchronization performance of each of the multiple micro mirrors in the micro mirror groups, when the multiple micro mirrors in the micro mirror groups are driven by the actuator groups arranged in the one-to-one correspondence with the micro mirror groups for tilting, is further improved, which can solve a problem in the related art of unsatisfactory tilting synchronization between multiple micro mirrors.

Additional aspects and advantages of the present disclosure will be provided at least in part in the following description, or will become apparent at least in part from the following description, or can be learned from practicing the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings.

FIG. 1 is a schematic diagram of a micro mirror array of a MEMS scanning mirror according to an embodiment of the present disclosure.

FIG. 2 is a schematic diagram of another micro mirror array of a MEMS scanning mirror according to an embodiment of the present disclosure.

FIG. 3 is a schematic diagram of yet another micro mirror array of a MEMS scanning mirror according to an embodiment of the present disclosure.

FIG. 4 is a schematic diagram of an actuation structure of a MEMS scanning mirror according to an embodiment of the present disclosure.

FIG. 5 is a schematic diagram of another actuation structure of a MEMS scanning mirror according to an embodiment of the present disclosure.

FIG. 6 is a specific embodiment of the actuation structure illustrated in FIG. 4.

FIG. 7 is a specific embodiment of the actuation structure illustrated in FIG. 5.

FIG. 8 is a schematic diagram of yet another actuation structure of a MEMS scanning mirror according to an embodiment of the present disclosure.

FIG. 9 is a schematic diagram of still yet another actuation structure of a MEMS scanning mirror according to an embodiment of the present disclosure.

FIG. 10 is a schematic structural diagram of a driving signal modulator according to an embodiment of the present disclosure.

FIG. 11 is a schematic diagram of an actuation structure equipped with a signal modulation circuit according to an embodiment of the present disclosure.

FIG. 12 is a schematic diagram of a micro mirror array according to a specific embodiment of the present disclosure.

FIG. 13 is a schematic structural view of a LiDAR system according to an embodiment of the present disclosure.

FIG. 14 is a schematic structural view of another LiDAR system according to an embodiment of the present disclosure.

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limit, the present disclosure.

In a MEMS scanning mirror in the related art, multiple micro mirrors are specifically prepared at a MEMS substrate, and multiple actuators are also prepared at the MEMS substrate to drive the multiple micro mirrors to tilt. In a technical solution for implementing the MEMS scanning mirror, each of the multiple actuators includes an electric actuator element, a spring, or the like prepared at the MEMS substrate, and the multiple micro mirrors are disposed on the spring. To achieve tilting of the multiple micro mirrors, a driving signal can be applied to the electric actuator element, in such a manner that the electric actuator element can drive the spring to be displaced under the driving signal, and the spring restores to an original position under a restoring force of the spring, completing one tilting action of each of the multiple micro mirrors.

Generally, the multiple micro mirrors can form a micro mirror array, and the multiple actuators can also form an actuator array. By simultaneously applying driving signals to the multiple actuators in the actuator array, the multiple micro mirrors can be driven to tilt synchronously. By continuously applying driving signals, a scanning function of the micro mirrors can be achieved, and a scanning mirror with a larger area can be formed. In the technology of implementing the MEMS scanning mirror using the above technical solutions, whether the multiple micro mirrors can tilt synchronously is one of the key technical issues that need to be paid attention to. Relevant research has provided some technical solutions to ensure synchronous tilting of the multiple micro mirrors, but it was found that since the multiple actuators at the MEMS are generally manufactured through etching and other processes, errors in the manufacturing process may lead to differences in performance parameters of the multiple actuators when the multiple actuators are manufactured. Such differences in the performance parameters lead to a problem that tilting synchronization between the multiple micro mirrors in the scanning mirror in operation is affected due to inconsistencies in the performance parameters of the multiple actuators even if the multiple actuators are driven by a same driving signal.

The errors in the manufacturing process result in characteristics in structures and/or dimensions of the multiple actuators, which lead to variations in performance parameters of the multiple actuators. The variations in the performance parameters are mainly reflected in synchronization performance between the multiple micro mirrors driven by the multiple actuators. For example, an exposure dosage variation during photolithography may result in a wider support beam in a predetermined region of the micro mirror array that supports the micro mirrors. The support beam may be part of the spring or connected to the spring, but it is part of a structure of the actuator in both cases. The wider support beam leads to an increase in an equivalent elasticity coefficient of the support beam, which in turn results in a smaller tilting amplitude of one of the multiple micro mirrors driven by the same driving signal, affecting performance of the tilting synchronization between the multiple micro mirrors in the micro mirror array.

The above exposure dosage variation during photolithography is a common occurrence in semiconductor manufacturing processes and is only described as an example. Other inconsistencies in the performance parameters may be caused by other process errors. However, it was found in a process of implementing the present disclosure that the semiconductor process errors mentioned above generally have a regional distribution characteristic, which in turn causes the performance parameters of the multiple actuators to present a regional distribution characteristic. That is, actuators adjacent to each other in a predetermined region may uniformly exhibit defects in one or several performance parameters, such as a high equivalent elasticity coefficient caused by widening of the support beam, non-uniform equivalent elasticity coefficients caused by non-uniform local stresses in silicon wafer bonding, or a large equivalent mass of the micro mirrors caused by locally thicker silicon structural layers. If the multiple micro mirrors are arranged in several rows and several columns, and corresponding actuators are also arranged in several rows and several columns, the regional distribution of the performance parameters of the multiple actuators may be a regional distribution in a row direction, a regional distribution in a column direction, or a regional distribution in both the row direction and the column direction, which is not limited in the embodiments of the present disclosure.

The MEMS scanning mirror according to the embodiments of the present disclosure provides a technical solution to improve the tilting synchronization between the multiple micro mirrors by addressing causes of the technical problem of unsatisfactory synchronization between the multiple micro mirrors. In the technical solution according to the embodiments of the present disclosure, the multiple micro mirrors in the micro mirror array at the MEMS are grouped into at least two micro mirror groups based on their positions. Each micro mirror group may include multiple micro mirrors adjacent to each other in position. In addition, the multiple actuators in the actuator array are also grouped into groups arranged in a one-to-one correspondence with the at least two micro mirror groups. Actuators in each actuator group are configured to drive micro mirrors in a corresponding one of the at least two micro mirror groups to tilt. A specific correspondence between actuators and micro mirrors may be a one-to-one correspondence, a one-to-many correspondence, or a many-to-one correspondence, which is not limited in the embodiments of the present disclosure, but the actuators in each actuator group are also adjacent to each other in position.

Referring to the above description, due to an influence of semiconductor manufacturing processes, the performance parameters of the multiple actuators have regional distribution characteristics. In the embodiments of the present disclosure, the micro mirror array and the actuator array are each grouped. For different micro mirror groups and actuator groups, since the micro mirrors in the same micro mirror group are adjacent to each other in position and the actuators in the same actuator group are also adjacent to each other in position, the consistency of the performance parameters of the actuators in the same actuator group is desirable. In this way, when the actuator group is driven by the same driving signal, synchronization performance of each of the multiple micro mirrors in the micro mirror groups, when the multiple micro mirrors in the micro mirror groups are driven by the actuator groups arranged in a one-to-one correspondence with the micro mirror groups for tilting, is further improved, which is closer to achieving final synchronous tilting.

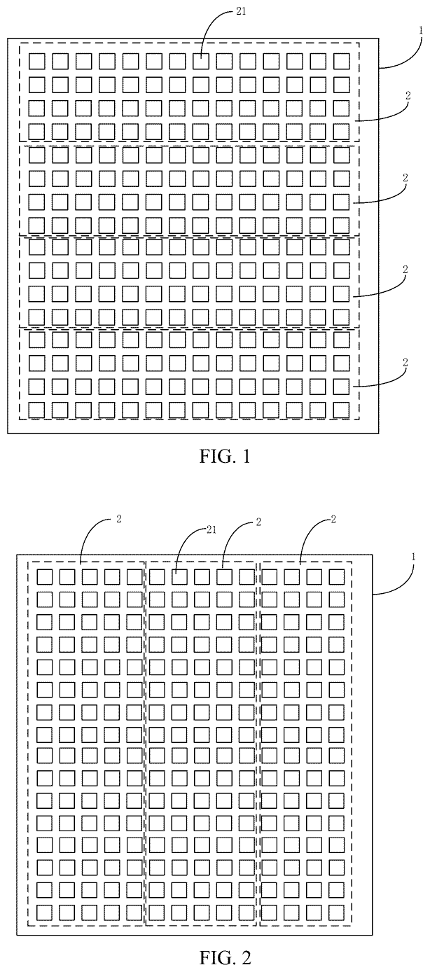

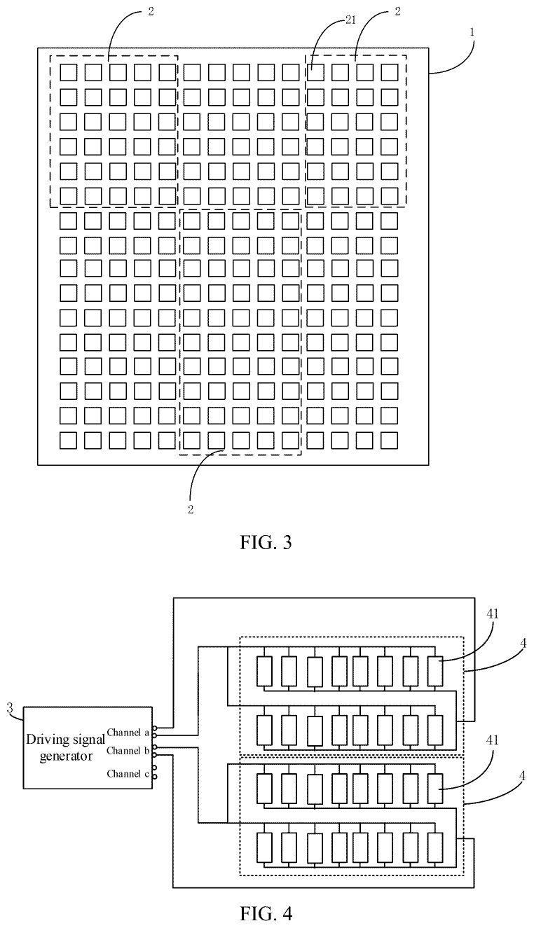

FIG. 1 to FIG. 3 each are a schematic diagram of a micro mirror array of a MEMS scanning mirror according to an embodiment of the present disclosure. As illustrated in FIG. 1 to FIG. 3, the MEMS scanning mirror includes a MEMS substrate 1 and at least two micro mirror groups 2 formed at the MEMS substrate 1. Each micro mirror group 2 includes multiple micro mirrors 21 adjacent to each other in position. Specifically, in the embodiments of the present disclosure, the micro mirrors 21 in each micro mirror group 2 being adjacent to each other in position may include various situations. For example, as illustrated in FIG. 1, the micro mirrors 21 in each micro mirror group 2 may be adjacent to each other in the row direction, that is, each micro mirror group 2 includes one or more adjacent rows of micro mirrors 21. Alternatively, as illustrated in FIG. 2, the micro mirrors 21 in each micro mirror group 2 may be adjacent to each other in the column direction, that is, each micro mirror group 2 includes one or more adjacent columns of micro mirrors 21. Alternatively, as illustrated in FIG. 3, the micro mirrors 21 in each micro mirror group 2 may be adjacent to each other in both the row direction and the column direction, that is, each micro mirror group 2 includes at least two adjacent rows of micro mirrors 21 in the row direction and at least two adjacent columns of micro mirrors 21 in the column direction. In this way, the micro mirror group 2 composed of micro mirrors 21 in a predetermined region is obtained. In the embodiments of the present disclosure, the compositions of the micro mirror group 2 illustrated in FIG. 1 to FIG. 3 are only examples, and the micro mirror group 2 formed by adjacent micro mirrors 21 in position can also be obtained through other methods.

FIG. 4 is a schematic diagram of an actuation structure of a MEMS scanning mirror according to an embodiment of the present disclosure. Specifically, as illustrated in FIG. 4, the actuation structure includes a driving signal generator 3 and an actuator array. The actuator array may also be grouped. For example, the actuator array may include at least two actuator groups 4 arranged in a one-to-one correspondence with the at least two micro mirror groups 2. For example, in the embodiments illustrated in FIG. 1 to FIG. 3 where three or four micro mirror groups 2 are included, actuator groups 4 in a corresponding quantity may also be included. In addition, actuators 41 in each actuator group 4 are configured to drive micro mirrors 21 in a corresponding one of the at least two micro mirror groups 2 to tilt.

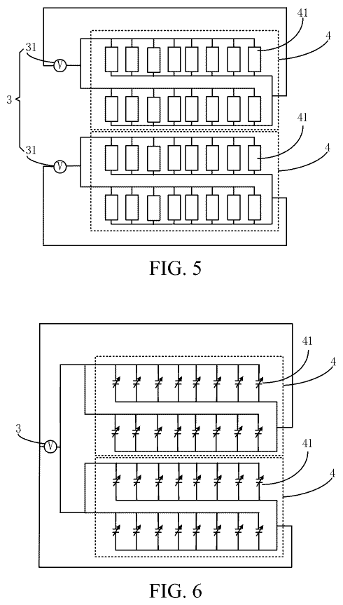

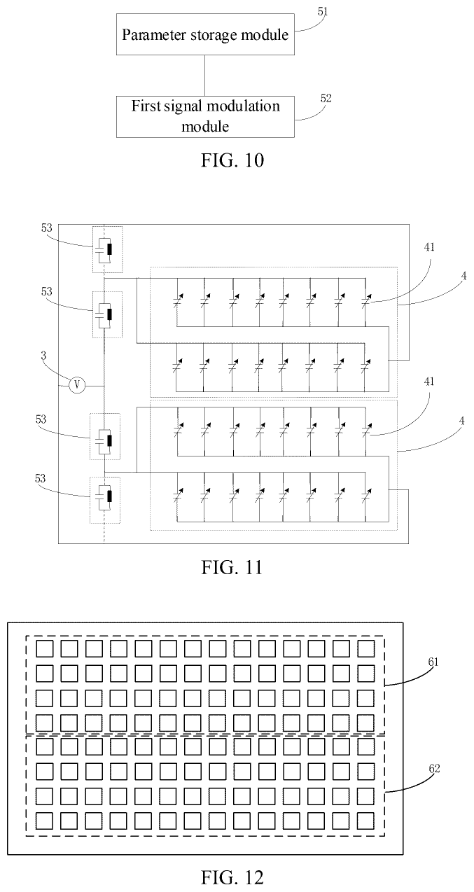

In the embodiment illustrated in FIG. 4, the micro mirror array of the MEMS scanning mirror includes two scanning mirror groups 2. In this case, two actuator groups 4 may be arranged correspondingly. In addition, in the embodiment illustrated in FIG. 4, the driving signal generator 3 may be configured to output, via different channels such as channel a, channel b, and channel c, driving signals to the actuator groups 4, respectively, in such a manner that the driving signal matching the performance parameter of actuators in each actuator group 4 may be output to the actuator group 4. To achieve the above objectives, as illustrated in FIG. 5, two driving signal generation units 31 may be disposed in the driving signal generator 3. Alternatively, only one driving signal generation unit may be disposed in the driving signal generator 3, but a driving signal modulator is also provided. The driving signal modulator may be disposed inside the driving signal generator 3. The driving signal modulator is configured to modulate the driving signals emitted by the driving signal generation unit to obtain driving signals adapted to the performance parameters of different actuator groups 4, and transmit the driving signals adapted to the performance parameters of different actuator groups 4 to the actuator groups, respectively. A specific structure of the driving signal modulator may be as illustrated in FIG. 10. The above modulation is performed by a first signal modulation module 52 based on the performance parameters stored in a parameter storage module 51. Alternatively, in other cases, as illustrated in FIG. 8, a driving signal modulator 5 is disposed outside the driving signal generator 3. The driving signal modulator 5 may be a resistor-capacitor network as illustrated in FIG. 11. The above objectives can be achieved in any of these cases. Alternatively, in some cases, as illustrated in FIG. 9, both two driving signal generation units 31 and two corresponding driving signal modulators 5 are provided.

In the embodiment illustrated in FIG. 5, the driving signal generator 3 includes driving signal generation units 31 in a same quantity as actuator groups 4. The driving signal generation units 31 are in a one-to-one correspondence with the actuator groups 4. The driving signal generation units 31 are configured to output driving signals to the actuator groups 4 in a one-to-one correspondence with the driving signal generation units 31.

In the embodiments illustrated in FIG. 1 to FIG. 5, the actuator 41 is configured to drive the micro mirror 21 corresponding to the actuator 41. A specific correspondence between actuators 41 and micro mirrors 21 may be any one of a one-to-one correspondence, a one-to-many correspondence, or a many-to-one correspondence, which is not limited in the embodiments of the present disclosure. With the technical solution provided in the embodiments of the present disclosure, the multiple micro mirrors 21 at the MEMS scanning mirror are grouped, and the multiple actuators 41 are grouped. In addition, the micro mirrors 21 in the same group are adjacent to each other in position, and the actuators 41 in the same group are also adjacent to each other in position. The consistency of the performance parameters of the actuators 41 in the same actuator group 4 is desirable. In this way, when the actuator group 4 is driven by the same driving signal, synchronization performance of each of the multiple micro mirrors 21 in the micro mirror groups 2, when the multiple micro mirrors 21 in the micro mirror groups 2 are driven by the actuator groups 4 arranged in a one-to-one correspondence with the micro mirror groups 2 for tilting, is further improved, which is closer to achieving the final synchronous tilting.

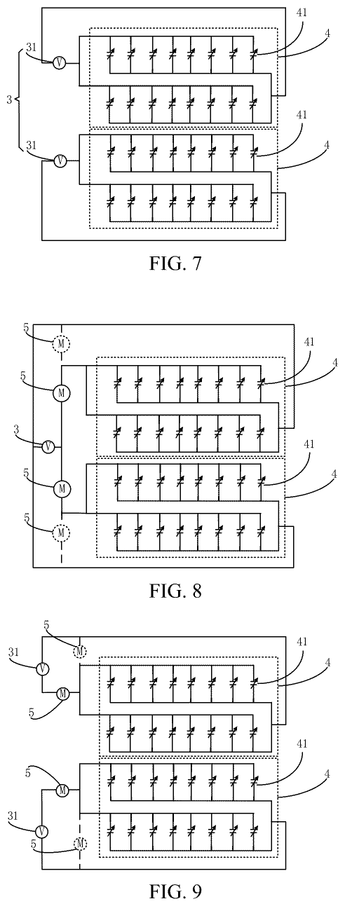

In the embodiments of the present disclosure, a type of the actuator is not limited. The actuators involved in the embodiments of the present disclosure may include actuators of a variety of types. For example, for various actuators that can be prepared at the MEMS through semiconductor processes, the above technical problems may arise due to an influence of process errors, all of which can be solved through the technical solutions provided according to the embodiments of the present disclosure. Specifically, the actuator in the embodiments of the present disclosure may be, for example, any one of an electrostatic actuator, an electric thermal actuator, a capacitive actuator, or a piezoelectric actuator. The electrostatic actuator can generally be implemented as an electrostatic comb actuator, which can be modeled as a variable capacitor electrically. Therefore, the technical solutions illustrated in FIG. 4 and FIG. 5 according to the embodiments of the present disclosure can be converted into technical solutions illustrated in FIG. 6 and FIG. 7, where the actuator may be regarded as a variable capacitor.

In the above embodiments of the present disclosure, the multiple micro mirrors 21 in the micro mirror array are grouped into multiple micro mirror groups 2 adjacent to each other based on their positions, and the actuator groups 4 are arranged to in a one-to-one correspondence with the multiple micro mirror groups 2, in such a manner that the actuators 41 in each actuator group 4 can be less affected by process errors during the manufacturing process and have substantially consistent performance parameters. In this way, the tilting synchronization between the multiple micro mirrors 21 in each micro mirror group 2 can be improved, but a problem of unsatisfactory tilting synchronization between the multiple micro mirror groups 2 may still exist. Therefore, in the embodiments of the present disclosure, corresponding driving signals can be configured for different actuator groups 4 by taking into account the characteristic that the actuators 41 within each actuator group 4 have substantially the same performance parameters, but a large difference exists between the performance parameters of the multiple actuator groups 4. That is, the driving signals outputted by the driving signal generator can be modulated using different signal modulation parameters to obtain driving signals matching the performance parameters of the multiple actuator groups 4, improving the tilting synchronization between the micro mirrors 21 driven by different actuator groups 4. That is, the synchronization performance between different micro mirror groups 2 is improved.

Specifically, as illustrated in FIG. 8 and FIG. 9, the driving signal modulator 5 is further included on the basis of the embodiments illustrated in FIG. 6 and FIG. 7. The driving signal modulator 5 is configured to modulate, based on signal modulation parameters, the driving signals outputted by the driving signal generator 3, and output the modulated driving signals to the actuator groups 4. The signal modulation parameter is mainly used to generate the driving signal matching the performance parameter of each actuator group 4, to achieve synchronous tilting between the micro mirror groups 2. In some specific embodiments, as illustrated in FIG. 8 and FIG. 9, the driving signal modulator 5 may be arranged in series and/or parallel with the actuator group 4 corresponding to the driving signal modulator 5, as long as the corresponding driving signal can be modulated. In FIG. 8 and FIG. 9, the driving signal modulator 5 represented by a solid line is connected in series with the actuator group 4 corresponding to the driving signal modulator 5, while the signal modulator 5 represented by a dashed line is connected in parallel with the actuator group 4 corresponding to the driving signal modulator 5.

In some embodiments, the signal modulation parameter may be obtained based on the performance parameter of each actuator group. As a modulation parameter for the performance parameter, the signal modulation parameter can improve synchronization performance of each actuator group when driving the multiple micro mirrors. During specific obtaining of the signal modulation parameter, as mentioned above, variations in the performance parameters of the multiple actuator groups are mainly due to the characteristics of the structures or the dimensions of the multiple actuators caused by the process errors in the semiconductor manufacturing process. Therefore, in consideration of this, in some embodiments, the signal modulation parameter may be obtained based on the characteristics of the structures or the dimensions, but such a scheme relies on accurate measurement of the characteristics of the structures or the dimensions of the multiple actuators and precise estimation of the variations in the performance parameters caused by different characteristics of the structures or the dimensions, which is difficult to realize. Alternatively, in other embodiments, synchronization performance tests may be pre-conducted. During the synchronization performance tests, driving signals may be applied to at least two actuator groups, and the driving signal applied to each actuator group may be continuously adjusted. Also, the synchronization between the micro mirror groups can be monitored. When optimal synchronization is obtained between the micro mirror groups, the adjusted signal modulation parameter can be used as the signal modulation parameter and recorded. The above signal modulation parameter is obtained. The signal modulation parameter may be at least one of a signal amplitude ratio of the driving signals applied to different actuator groups or a phase difference of the driving signals applied to different actuator groups.

In the embodiments of the present disclosure, the signal modulation parameter of each actuator group may be pre-obtained through any of the above approaches, and each actuator group may be driven based on the signal modulation parameter. Such an implementation may be realized as an open-loop control technical solution, which mainly takes into account that the MEMS is a stable mechanical system with little impact on system performance from changes in an external environment. In addition, for different actuator groups and micro mirror groups, an environmental impact is weak and similarly has little impact on synchronization performance of the different actuator groups and micro mirror groups. Therefore, using the open-loop control to pre-obtain the signal modulation parameter corresponding to each actuator group and modulate the driving signal based on the pre-obtained signal modulation parameter is also a satisfactory technical solution. Compared with a conventional close-loop control technical solution using negative feedback, the open-loop technical solution directly uses the above signal modulation parameter when in operation on a basis of the pre-obtained signal modulation parameter, without performing high-speed performance tests and calculation. Therefore, the multiple micro mirrors in the MEMS scanning mirrors can be driven like a single scanning mirror.

The signal modulation parameter in the above embodiments specifically includes at least one of a signal amplitude ratio of the driving signals between different actuator groups or a phase difference of the driving signals between different actuator groups. In a case where different types of actuators are provided in the actuator group, the signal amplitude ratio of the driving signals between different actuator groups may be a voltage amplitude value or a current amplitude value. For example, for the problem mentioned in the above embodiments that some actuators have wider support beams that result in the increase in the equivalent elasticity coefficient of the support beams, which in turn reduces the tilting amplitude when the same driving signal is applied, improvement can be made by increasing the signal amplitude value of the driving signal, such as adjusting the voltage amplitude value or the current amplitude value.

In the above embodiments of the present disclosure, if the open-loop control solution is used to obtain the signal modulation parameter, the signal modulation parameter of each actuator group may be pre-stored in a parameter storage module, and a signal modulation module is also provided to modulate the driving signal based on the signal modulation parameter of each actuator group stored in the parameter storage module. FIG. 10 is a schematic structural diagram of a driving signal modulator according to an embodiment of the present disclosure. Specifically, as illustrated in FIG. 10, the driving signal modulator includes a parameter storage module 51 and a signal modulation module 52. The parameter storage module 51 is configured to store the signal modulation parameter of each actuator group 4. For at least two actuator groups 4, the signal modulation parameters of the at least two actuator groups 4 are stored by the parameter storage module 51. The signal modulation module 52 is configured to read the signal modulation parameters from the parameter storage module 51 and modulate the driving signals of the at least two actuator groups 4 based on the signal modulation parameters. As described above, the signal modulation parameters are obtained by performing a synchronization performance detection on different micro mirror groups. The driving signals modulated by various signal modulation parameters, when applied to the multiple actuator groups 4, can improve the synchronization performance between the multiple micro mirror groups driven by the multiple actuator groups. In this embodiment, the signal modulation parameters are pre-obtained and added to the parameter storage module 51. Subsequently, during the operation of the MEMS scanning mirror, the signal modulation parameters can be conveniently obtained from the parameter storage module 51 for modulating. The parameter storage module 51 may be various forms of memory, such as a non-volatile memory. In the case where the signal modulation parameter may include at least one of the signal amplitude ratio of the driving signals between different actuator groups or the phase difference of the driving signals between different actuator groups, the signal modulation module 52 may include at least one of a phase modulation circuit and a signal amplitude modulation circuit to perform phase modulation or signal amplitude modulation based on the signal modulation parameter.

For the open loop control technical solution, in addition to the embodiment illustrated in FIG. 10, the driving signal modulator 5 may also include a signal modulation circuit 53. FIG. 11 is a schematic diagram of an actuation structure equipped with a signal modulation circuit according to an embodiment of the present disclosure. As illustrated in FIG. 11, the signal modulation circuit 53 may be directly prepared at the MEMS substrate based on the signal modulation parameters of the at least two actuator groups 4. Alternatively, the signal modulation circuit 53 may be arranged externally, and may be connected to a driving circuit of the actuator group 4. That is, the signal modulation circuit 53 may be arranged in parallel and/or in series with a corresponding actuator group. As illustrated in FIG. 11, the signal modulation circuit 53 arranged in parallel with the corresponding actuator group 4 or the signal modulation circuit 53 arranged in series with the corresponding actuator group 4 is included. With the signal modulation circuit 53 as described above, the driving signal outputted by the driving signal generator 3 is modulated by the signal modulation circuit 53. Since the signal modulation circuit 53 is prepared based on the signal modulation parameter of the corresponding actuator group, the prepared signal modulation circuit 53 can accurately reflect specific needs of signal modulation, improving the synchronization of the micro mirrors in micro mirror groups driven by the multiple actuator groups using the driving signals modulated by the signal modulation circuit 53.

In the embodiments of the present disclosure, the signal modulation circuit 53 may be prepared at the MEMS substrate through, for example, an integrated circuit manufacturing process, which may be carried out based on the signal modulation parameters of the at least two actuator groups 4 obtained through testing after each actuator in the at least two actuator groups 4 is prepared. Alternatively, in some cases, the signal modulation circuit 53 may be constructed through selecting an appropriate external device based on the signal modulation parameter and may be disposed at the MEMS substrate.

In some embodiments, as illustrated in FIG. 11, the signal modulation circuit includes a resistor-capacitor network. That is, resistors and capacitors may be used as constituent elements of the signal modulation circuit 53. The signal modulation circuit 53 composed of capacitors and resistors is configured to perform phase modulation and/or signal amplitude modulation. The capacitors can mainly provide phase modulation, while the resistors can provide signal amplitude modulation. As described in the above embodiments, the signal modulation parameter includes at least one of the signal amplitude ratio of the driving signals between different actuator groups or the phase difference of the driving signals between different actuator groups. In the embodiments of the present disclosure, specific capacitance values of the capacitors and specific resistance values of the resistors in the signal modulation circuit 53 may be determined based on the signal modulation parameters. In some cases, the resistor-capacitor network may also be synchronously generated in a MEMS manufacturing process of the actuator group 4. However, since the signal adjustment parameter of each actuator group 4 is obtained without any test, laser tailoring process needs to be performed to obtain the required resistance and capacitance values for at least one of the resistors and the capacitors after obtaining the signal modulation parameter of the actuator group 4, and thus the signal modulation circuit 53 as required is obtained.

FIG. 12 is a schematic diagram of a micro mirror array according to a specific embodiment of the present disclosure. As illustrated in FIG. 12, the micro mirror array includes two micro mirror groups, namely a first micro mirror group 61 and a second micro mirror group 62 in FIG. 12. The first micro mirror group 61 and the second micro mirror group 62 are used for a beam emitting side and a beam receiving side, respectively. Specifically, this specific embodiment mainly describes an application scenario of a coaxial LiDAR system, where the MEMS scanning mirror is applied to both the beam emitting side and the beam receiving side. The scanning mirror at the beam emitting side is configured to reflect laser beams emitted by a laser source. The scanning mirror at the beam receiving side is configured to reflect the reflected beam from a target region. In this application scenario, laser divergence at the beam emitting side needs to be reduced to ensure high angle resolution. Therefore, a high requirement is imposed on the synchronization performance of the first micro mirror group 61. For the beam receiving side, due to a laser time-of-flight requirement, a laser divergence requirement is much relaxed. Therefore, a low requirement is imposed on the synchronization performance of the second micro mirror group 62, and a low requirement is also imposed on the performance of micro mirror tilting synchronization between the first micro mirror group 61 and the second micro mirror group 62. Therefore, in this application scenario, the technical solutions provided by the above embodiments reveal that, since the first micro mirror group 61 and the second micro mirror group 62 are arranged separately, the tilting synchronization between the micro mirrors in the first micro mirror group 61 can be improved, improving the synchronization performance of the laser beam at the beam emitting side. This technical solution is suitable for an application scenario of a coaxial LiDAR system.

The MEMS scanning mirror according to any of the above embodiments of the present disclosure can be applied to a LiDAR system capable of achieving light detection and ranging functions. Generally, the LiDAR system includes the coaxial LiDAR system as described above and a non-coaxial LiDAR system, which may also be referred to as a paraxial LiDAR system. An optical path of the coaxial LiDAR system is reversible, meaning that the reflected light from the target region still passes through the scanning mirror and then is guided to a photodetector through a beam splitter. In applications of the non-coaxial LiDAR system, the reflected light from the target region directly reaches the photodetector through a bypass optical path. The MEMS scanning mirror according to the above embodiments of the present disclosure is applicable to technical solutions for both the coaxial LiDAR system and the non-coaxial LiDAR system.

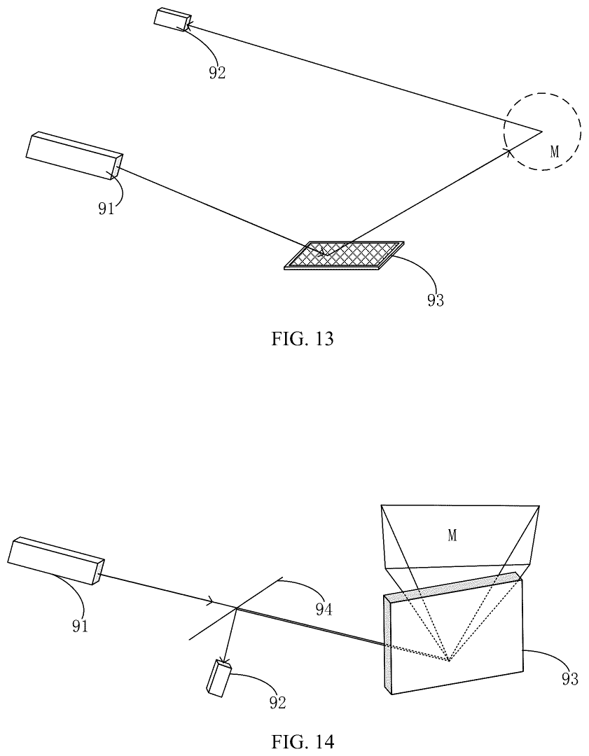

FIG. 13 is a schematic structural view of a LiDAR system according to an embodiment of the present disclosure, which is a technical solution of the paraxial LiDAR system. As illustrated in FIG. 13, the LiDAR system includes a light source 91, a photodetector 92, and a MEMS scanning mirror 93. A laser beam emitted by the light source 91 is reflected to a target region M by the MEMS scanning mirror 93. The photodetector 92 is configured to receive at least part of reflected light from the target region M and convert the at least part of the reflected light into an electrical signal. The LiDAR system further includes a processor configured to obtain a laser point cloud from the target region based on the electrical signal outputted by the photodetector 92. Based on the laser point cloud mentioned above, light detection and ranging functions can be achieved.

FIG. 14 is a schematic structural view of another LiDAR system according to an embodiment of the present disclosure, which is a technical solution of the coaxial LiDAR system. As illustrated in FIG. 14, the LiDAR system includes a light source 91, a photodetector 92, and a MEMS scanning mirror 93. The difference is that, unlike the paraxial LiDAR system technical solution illustrated in FIG. 13, the embodiment illustrated in FIG. 14 further includes a beam splitter 94, in such a manner that the laser beam emitted by the light source 91 passes through the beam splitter 94 and the MEMS scanning mirror 93 in sequence, and is reflected by the MEMS scanning mirror 93 to the target region M for scanning the target region M. At least part of the reflected light from the target region M may also pass through the MEMS scanning mirror 93 to the beam splitter 94, the reflected light is guided to the photodetector 92 by the beam splitter 94, in such a manner that the photodetector 92 can convert the reflected light into an electrical signal. Further, when a processor is also included in the LiDAR system, the processor is configured to obtain a laser point cloud from the target region based on the electrical signal outputted by the photodetector, achieving light detection and ranging functions. The light source 91, the photodetector 92, and the beam splitter 94 in this embodiment may also form a laser transceiver module to achieve laser emission and detection.

The LiDAR system according to any of the embodiments illustrated in FIG. 13 and FIG. 14 of the present disclosure may use any of the MEMS scanning mirrors according to the embodiments illustrated in FIG. 1 to FIG. 12, and therefore has corresponding technical effects.

In the embodiments of the present disclosure, for the MEMS scanning mirror applied in the LiDAR system, the micro mirrors in the micro mirror array are grouped into at least two micro mirror groups based on positions. Each micro mirror group may include multiple micro mirrors adjacent to each other in position. In addition, the multiple actuators in the actuator array are also grouped into at least two actuator groups arranged in the one-to-one correspondence with the at least two micro mirror groups. Each actuator group includes multiple actuators adjacent to each other in position. The actuators in each actuator group are configured to drive the micro mirrors in the corresponding one of the at least two micro mirror groups to tilt. The specific correspondence between the actuators and the micro mirrors may be a one-to-one correspondence, a one-to-many correspondence, or a many-to-one correspondence, which is not limited in the embodiments of the present disclosure, but the actuators in each actuator group are also adjacent to each other in position. Due to the influence of semiconductor manufacturing processes, the performance parameters of the multiple actuators have regional distribution characteristics. In the embodiments of the present disclosure, the micro mirror array and the actuator array are each grouped. For different micro mirror groups and actuator groups, since the micro mirrors in the same micro mirror group are adjacent to each other in position and the actuators in the same actuator group are also adjacent to each other in position, the consistency of the performance parameters of the actuators in the same actuator group is desirable. In this way, when the actuator group is driven by the same driving signal, the synchronization performance of each of the multiple micro mirrors in the micro mirror groups, when the multiple micro mirrors in the micro mirror groups are driven by the actuator groups arranged in the one-to-one correspondence with the micro mirror groups for tilting, is further improved, which can solve the problem in the related art of unsatisfactory tilting synchronization between multiple micro mirrors in each micro mirror group.

Further, in the embodiments of the present disclosure, corresponding driving signals can be configured for different actuator groups by taking into account the characteristic that the actuators within each actuator group have substantially the same performance parameters, but a large difference exists between the performance parameters of the actuators in each actuator group. That is, the driving signals outputted by the driving signal generator can be modulated using different signal modulation parameters to obtain driving signals matching the performance parameters of the multiple actuator groups, and the modulated driving signals are applied to the multiple actuators, improving the tilting synchronization between the micro mirrors driven by different actuator groups. That is, the synchronization performance between different micro mirror groups is improved.

In the above embodiments of the present disclosure, with regard to the technical solution of the coaxial LiDAR system illustrated in FIG. 14, since the laser beam emitted by the light source 91 and the reflected light from the target region M both pass through the MEMS scanning mirror 93, the MEMS scanning mirror 93 includes the first micro mirror group 61 and the second micro mirror group 62 as illustrated in FIG. 12. As mentioned above, the high requirement is imposed on the synchronization performance of micro mirrors in the first micro mirror group 61, the low requirement is imposed on the synchronization performance of micro mirrors in the second micro mirror group 62, and the low requirement is also imposed on the synchronization performance between micro mirrors in the first micro mirror group 61 and the second micro mirror group 62. Therefore, in the technical solution, improving the synchronization between the two micro mirror groups mentioned above can still meet the requirements, even without considering the use of signal modulation parameters. In addition, the driving signal generator is applicable to the embodiment illustrated in FIG. 5. By providing an independent driving signal generation unit 31, the first micro mirror group 61 and the actuator group corresponding to the first micro mirror group 61 can be separated from the second micro mirror group 62 and the actuator group corresponding to the second micro mirror group 62 both electrically and mechanically.

Terms such as “first” and “second” in the specification of the present disclosure and the appended claims are used only to distinguish between similar objects, rather than to describe a particular order or sequence. It should be understood that the data as used can be interchanged where appropriate, to enable the embodiments of the present disclosure described herein to be implemented in an order other than that illustrated or described herein. Also, the objects distinguished by the terms such as “first” and “second” are usually objects of the same type. The quantity of the objects is not limited. For example, one or a plurality of first objects may be provided. In addition, “and/or” throughout the specification and appended claims indicates at least one of the objects associated with “and/or”. The character “/” generally indicates that the associated objects before and after the character are in an “or” relationship.

In the description of the present disclosure, it should be understood that, the orientation or the position indicated by terms such as “center”, “longitudinal”, “lateral”, “length”, “width”, “thickness”, “over”, “below”, “front”, “rear”, “left”, “right”, “vertical”, “horizontal”, “top”, “bottom”, “inner”, “outer”, “clockwise”, “anti-clockwise”, “axial”, “radial”, and “circumferential” should be construed to refer to the orientation and the position as shown in the drawings, and is only for the convenience of describing the present disclosure and simplifying the description, rather than indicating or implying that the pointed device or element must have a specific orientation, or be constructed and operated in a specific orientation, and therefore cannot be understood as a limitation of the present disclosure.

In the description of the present disclosure, “first feature” and “second feature” may include one or more of these features.

In the description of the present disclosure, “plurality” means two or more.

In the description of the present disclosure, the first feature “on” or “under” the second feature may mean that the first feature is in direct contact with the second feature, or the first and second features are in indirect contact through another feature between them.

In the description of the present disclosure, the first feature “above” the second feature means that the first feature is directly above or obliquely above the second feature, or simply means that the level of the first feature is higher than that of the second feature.

Reference throughout this specification to “an embodiment”, “some embodiments”, “illustrative embodiments”, “an example”, “a specific example”, or “some examples” means that a particular feature, structure, material, or characteristic described in connection with the embodiment or example is included in at least one embodiment or example of the present disclosure. The appearances of the above phrases in various places throughout this specification are not necessarily referring to the same embodiment or example. Further, the particular features, structures, materials, or characteristics may be combined in any suitable manner in one or more embodiments or examples.

Although embodiments of the present disclosure have been illustrated and described, it is conceivable for those skilled in the art that various changes, modifications, replacements, and variations can be made to these embodiments without departing from the principles and spirit of the present disclosure. The scope of the present disclosure shall be defined by the claims as appended and their equivalents.

What is claimed is:

1. A micro-electro-mechanical system (MEMS) scanning mirror, comprising:
at least two micro mirror groups formed at a MEMS substrate, each of the at least two micro mirror groups comprising a plurality of micro mirrors adjacent to each other;
at least two actuator groups arranged in a one-to-one correspondence with the at least two micro mirror groups, actuators in each of the at least two actuator groups being configured to drive micro mirrors in a corresponding one of the at least two micro mirror groups to tilt; and
a driving signal generator configured to output a driving signal to each of the at least two actuator groups, enabling each of the at least two actuator groups to drive, based on the driving signal, the micro mirrors in the corresponding one of the at least two micro mirror groups to tilt synchronously.

2. The MEMS scanning mirror according to claim 1, wherein the plurality of micro mirrors are arranged in an array at the MEMS substrate, each of the at least two micro mirror groups comprising at least two rows of micro mirrors adjacent to each other, and/or each of the at least two micro mirror groups comprising at least two columns of micro mirrors adjacent to each other.

3. The MEMS scanning mirror according to claim 1, wherein the driving signal generator comprises:
at least two driving signal generation units arranged in a one-to-one correspondence with the at least two actuator groups, each of the at least two driving signal generation units being configured to output the driving signal to a corresponding one of the at least two actuator groups.

4. The MEMS scanning mirror according to claim 1, further comprising:
a driving signal modulator configured to modulate, based on a signal modulation parameter of the at least two actuator groups, the driving signals outputted by the driving signal generator, and apply the modulated driving signals to the at least two actuator groups, the signal modulation parameter being used to enable the plurality of micro mirrors in different micro mirror groups to tilt synchronously.

5. The MEMS scanning mirror according to claim 4, wherein the signal modulation parameter is obtained by performing a synchronous performance detection on the plurality of micro mirrors in different micro mirror groups.

6. The MEMS scanning mirror according to claim 4, wherein the signal modulation parameter comprises at least one of a signal amplitude ratio of the driving signals between different actuator groups or a phase difference of the driving signals between different actuator groups.

7. The MEMS scanning mirror according to claim 5, wherein the driving signal modulator comprises:
a parameter storage module configured to store the signal modulation parameter of the at least two actuator groups; and
a signal modulation module configured to read the signal modulation parameter from the parameter storage module and modulate the driving signals of the at least two actuator groups based on the signal modulation parameter.

8. The MEMS scanning mirror according to claim 5, wherein the driving signal modulator comprises:
a signal modulation circuit arranged in parallel and/or in series with a corresponding one of the at least two actuator groups, the signal modulation circuit being configured to modulate the driving signal outputted by the driving signal generator, and the signal modulation circuit being prepared at the MEMS substrate based on the signal modulation parameter of the at least two actuator groups or arranged externally.

9. The MEMS scanning mirror according to claim 8, wherein the signal modulation circuit comprises a resistor-capacitor network.

10. The MEMS scanning mirror according to claim 1, wherein the at least two micro mirror groups comprise a first micro mirror group and a second micro mirror group, the first micro mirror group and the second micro mirror group being used for a beam emitting side and a beam receiving side, respectively.

11. A laser detection and ranging (LiDAR) system, comprising a light source, a photodetector, a processor, and a micro-electro-mechanical system (MEMS) scanning mirror, wherein:
a laser beam emitted by the light source is reflected to a target region by the MEMS scanning mirror;
the photodetector is configured to receive at least part of reflected light from the target region and convert the at least part of the reflected light into an electrical signal;
the processor is configured to obtain a laser point cloud from the target region based on the electrical signal; and
the MEMS scanning mirror comprises:
at least two micro mirror groups formed at a MEMS substrate, each of the at least two micro mirror groups comprising a plurality of micro mirrors adjacent to each other;
at least two actuator groups arranged in a one-to-one correspondence with the at least two micro mirror groups, actuators in each of the at least two actuator groups being configured to drive micro mirrors in a corresponding one of the at least two micro mirror groups to tilt; and
a driving signal generator configured to output a driving signal to each of the at least two actuator groups, enabling each of the at least two actuator groups to drive, based on the driving signal, the micro mirrors in the corresponding one of the at least two micro mirror groups to tilt synchronously.

12. The LiDAR system according to claim 11, wherein the plurality of micro mirrors are arranged in an array at the MEMS substrate, each of the at least two micro mirror groups comprising at least two rows of micro mirrors adjacent to each other, and/or each of the at least two micro mirror groups comprising at least two columns of micro mirrors adjacent to each other.

13. The LiDAR system according to claim 11, wherein the driving signal generator comprises:
at least two driving signal generation units arranged in a one-to-one correspondence with the at least two actuator groups, each of the at least two driving signal generation units being configured to output the driving signal to a corresponding one of the at least two actuator groups.

14. The LiDAR system according to claim 11, wherein the MEMS scanning mirror further comprises:
a driving signal modulator configured to modulate, based on signal modulation parameter of the at least two actuator groups, the driving signals outputted by the driving signal generator, and apply the modulated driving signals to the at least two actuator groups, the signal modulation parameter being used to enable the plurality of micro mirrors in different micro mirror groups to tilt synchronously.

15. The LiDAR system according to claim 14, wherein the signal modulation parameter is obtained by performing a synchronous performance detection on the plurality of micro mirrors in different micro mirror groups.

16. The LiDAR system according to claim 14, wherein the signal modulation parameter comprises at least one of a signal amplitude ratio of the driving signals between different actuator groups or a phase difference of the driving signals between different actuator groups.

17. The LiDAR system according to claim 15, wherein the driving signal modulator comprises:
a parameter storage module configured to store the signal modulation parameters of the at least two actuator groups; and
a signal modulation module configured to read the signal modulation parameters from the parameter storage module and modulate the driving signals of the at least two actuator groups based on the signal modulation parameter.

18. The LiDAR system according to claim 15, wherein the driving signal modulator comprises:
a signal modulation circuit arranged in parallel and/or in series with a corresponding one of the at least two actuator groups, the signal modulation circuit being configured to modulate the driving signal outputted by the driving signal generator, and the signal modulation circuit being prepared at the MEMS substrate based on the signal modulation parameter of the at least two actuator groups or arranged externally.

19. The LiDAR system according to claim 18, wherein the signal modulation circuit comprises a resistor-capacitor network.

20. The LiDAR system according to claim 15, wherein the at least two micro mirror groups comprise a first micro mirror group and a second micro mirror group, the first micro mirror group and the second micro mirror group being used for a beam emitting side and a beam receiving side, respectively.
